(19) United States
(12) Patent Application Publication
(10) Pub. No.: US 2007/0051011 A1
(43) Pub. Date: Mar. 8, 2007

(54) APPARATUS FOR DIVIDING A BATCH OF LAUNDRY, AND APPARATUS FOR TREATING LAUNDRY

(76) Inventors: Wilhelm Bringewatt, Porta Westfalica (DE); Engelbert Heinz, Vlotho (DE)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/468,468

(22) Filed: Aug. 30, 2006

(30) Foreign Application Priority Data
Sep. 6, 2005 (DE) 102005042382.5

(51) Int. Cl. F26B 19/00; F26B 3/00

(52) U.S. Cl. 34/500; 34/60

(57) ABSTRACT

The invention makes provision for the weight of the batch of laundry of that laundry machine whose batch is to be divided to be continuously determined. To this end, the weight of the laundry machine together with the laundry which is currently located therein is preferably continuously weighed. The weight of the partial batch which is respectively unloaded from the laundry machine is then given by subtracting the weight of the laundry remaining in the laundry machine from the total weight of the batch of laundry in the laundry machine.

### STATEMENT OF RELATED APPLICATIONS

This patent application claims convention priority on German Patent Application No. 10 2005 042 382.5 having a filing date of 6 Sep. 2005.

### BACKGROUND OF THE INVENTION

1. Technical Field

The invention relates to a method for dividing a batch of laundry which is treated in a laundry machine, into a plurality of partial batches. The invention also relates to an apparatus for treating laundry, comprising a drum, which can preferably be driven in rotation, for accommodating a batch of the laundry to be treated.

2. Prior Art

Apparatuses of the type discussed here are usually used in commercial laundries. They serve either to wash and spin-dry (spin dryer), only to spin-dry (laundry centrifuge) or to dry (tumble dryer) the laundry. The term laundry does not only mean items of clothing and domestic laundry, but also other articles to be washed, for example mats.

In laundries, laundry is washed, spun-dry and dried, amongst other things. This can be done in separate laundry machines, specifically in washing machines, laundry centrifuges and tumble dryers. In this case, the laundry has to be transferred from the washing machine to the laundry centrifuge and again from the laundry centrifuge to the dryer. In the case of spin dryers, the laundry is washed and spun-dry in the same laundry machine. In this case, it is necessary to transfer the laundry from the spin dryer to the dryer. In many cases, said laundry machines have different capacities and/or cycle times. As a result, different amounts of laundry (batches) are treated in the successive laundry machines. By way of example, a spin dryer or a laundry centrifuge may accommodate a greater amount of laundry, that is to say a larger batch, than a tumble dryer for example. However, the cycle time of the tumble dryer is then usually less than the cycle time of the spin dryer or laundry centrifuge. In order to compensate for these differences, it is known to carry out so-called batch division. The relatively large batch is generally divided into two partial batches of equal size. However, it is also feasible to divide, the relatively large batch into more than two partial batches, preferably also of the same size. To date, batch division has been carried out more or less at random.

### BRIEF SUMMARY OF THE INVENTION

The object of the present invention is to provide a method and an apparatus with which relatively exact batch division is also possible in a simple manner.

One method for achieving this object is a method for dividing a batch of laundry which is treated in a laundry machine into a plurality of partial batches, wherein the weight of the laundry in the laundry machine is determined. According to this, provision is made to determine the weight of the laundry in the laundry machine. Therefore, the weight of the laundry in at least one laundry machine is known, as a result of which deliberate batch division can be performed.

According to one preferred development of the method, provision is made for the weight of the laundry in the respective laundry machine to be determined before or at the beginning of and during unloading of the laundry from the laundry machine. The weight of the laundry in the respective laundry machine is expediently determined continuously. Continuous weight determination is to be understood to be weight determination which is constant, that is to say without interruption, or is performed at successive time intervals, so that breaks of preferably equal length, in which the weight is not measured, interrupt the individual weight measurements. The amount of laundry located in the drum, specifically the weight thereof, can therefore be established in a simple manner at the time of the respective weight determination. The total weight of the batch of laundry can be established by measuring the weight before or at the beginning of unloading of the laundry. On account of the subsequent weight measurements, it is possible to establish the residual amount of laundry still located in the laundry machine at the time of the respective weight determination. The weight of the partial batch of laundry which is already unloaded from the laundry machine can accordingly be determined in a reliable manner.

The weight of the unloaded partial batch is preferably determined by subtracting the weight of the laundry which is still located in the laundry machine from the total weight of the batch of laundry in the laundry machine which was determined initially. It is therefore possible to determine the exact weight of the partial batch which is already unloaded in a simple manner by means of temporally successive measurements on the respective laundry machine. The unloading process is stopped at that moment at which the partial batch which is already unloaded reaches the intended weight. This is usually the total weight of the batch divided by the number of partial batches. The individual partial batches are then formed by the unloading process being continued after an unloading break which follows the formation of the first partial batch, with the corresponding number of partial batches having preferably identical amounts, specifically weights, of laundry.

If only two partial batches of approximately the same weight are to be formed, only such an amount of laundry is unloaded until the weight of the laundry remaining in the laundry machine corresponds to half the weight of the entire batch of laundry which was previously determined. As a result, batch division into two batches of approximately the same weight can be carried out directly.

According to one preferred development of the method, provision is made for the laundry from the laundry machine to be loaded onto a conveyor. This conveyor may be an unloading belt for example. After the respective partial batch is formed, it can be conveyed away from the laundry machine, so that the next partial batch, which is separate from the preceding partial batch, can be formed.

Provision is further made for the first partial batch to be transported from the conveyor directly to the subsequent laundry machine, with the or each subsequent partial batch being intermediately held on the conveyor, that is to say stored, until the subsequent laundry machine is free to receive the next partial batch. This intermediate storage of the partial batches means that the preceding laundry machine can be completely unloaded without being dependent on the cycle time and capacity of the following laundry machine. In this way, the laundry machines can be operated independently of one another.

An apparatus for achieving the object mentioned in the introduction is an apparatus for treating laundry, comprising a drum, which can preferably be driven in rotation, for accommodating a batch of the laundry to be treated, distinguished by at least one weight sensor for determining at least the weight of the drum together with the laundry which is located therein at the time at which the weight is determined. The instantaneous weight of the batch of laundry in the respective apparatus (laundry machine) can be determined in a simple and reliable manner by providing at least one weight sensor for determining at least the weight of the drum and the laundry which is located therein.

Provision is also made for the at least one weight sensor to be associated with a basic frame for mounting the drum. Particularly simple weight determination is possible as a result. Although the entire apparatus or at least a large part thereof is determined when the weight of the batch of laundry in the drum is determined, the amount by which the determined weight exceeds the known weight of the basic frame and the drum necessarily gives the weight of the batch of laundry in the drum, since the weight of the drum and of the basic frame are known and do not change.

The at least one weight sensor is preferably arranged in the vicinity of a foot which is used to support the basic frame on the floor and/or is associated with this foot. In one preferred refinement of the invention, the at least one weight sensor is arranged in the basic frame, preferably above the foot on which the weight sensor which bears the basic frame and the drum is supported. As a result, the weight sensor is protected by the basic frame.

The basic frame and the drum are supported on the at least one weight sensor, with this weight sensor in turn being supported on its associated foot. The at least one weight sensor thus determines the weight of the basic frame comprising the drum, including the dry or wet laundry it contains. Therefore, that force is determined with which the basic frame, the drum and the possibly still wet laundry is supported on the foot which is associated with the weight sensor at that instant, that is to say at the time of the weight measurement. The apparatus is therefore virtually weighed, to be precise expediently a number of times or continuously (with or without breaks between the individual weighing operations)

In one preferred apparatus, each foot of the basic frame has its own, preferably individual, associated weight sensor. These are generally identical weight sensors in this case. An apparatus with, for example, four feet then has four weight sensors, to be precise one for each foot.

The plurality of weight sensors mean particularly precise weight measurement is possible. In addition, the weight measurement can also be carried out if one weight sensor fails. However, the main thing is that the dynamic forces and periodically changing weights can thus be established more reliably and more precisely, so that the weight of the laundry which is located in the drum at that instant can still be reliably determined even when the drum is driven in rotation. The rotation of the drum therefore does not influence the result of the determination of the weight of the laundry which is located in the drum. In particular, the result of the weight measurement which is performed during rotation of the drum is not corrupted.

Suitable weight sensors include all the known designs, for example pressure pickup cells, piezoelements, strain gauges, spring carriages or the like. The weight sensors are preferably in the form of load cells. For example, shear beam load cells are used which operate in accordance with the 6-wire technique with measurement amplifiers and have a weighing range of up to 5 t.

### BRIEF DESCRIPTION OF THE DRAWINGS

One preferred exemplary embodiment of the invention is explained in greater detail below with reference to the drawing, in which:

FIG. 1 shows a basic side view of the apparatus together with a downstream unloading belt and a dryer which can be loaded by said belt.

FIG. 2 shows a front view of the apparatus from FIG. 1.

FIG. 3 shows an enlarged detail III from FIG. 2, in the region of a foot of a basic frame of the apparatus.

### DETAILED DESCRIPTION OF THE PREFERRED EMBODIMENTS

The figures show an apparatus which is in the form of a spin dryer 10 for use in commercial laundries in particular.

The spin dryer 10 has a drum 12 which can be driven in rotation about a pivotable axis of rotation 11, and liquid can pass through said drum through at least partial perforations in its casing surface. The free end face of the drum 12 has a single opening 13 which takes up substantially the entire face.

The spin dryer 10 also has a water-tight drum housing 14 which surrounds the water-permeable drum 12. The drum housing 14 is formed such that it is stationary in relation to the drum 12, that is to say, in contrast to the drum 12, cannot be driven in rotation. A free end face of the drum housing 14 also has a single opening 15 which takes up virtually the entire face. The opening 15 is associated with that end face of the drum housing 14 toward which the opening 13 in the drum 12 also points. The openings 13 and 15 are therefore situated adjacent to one another since they correspond to one another. In the spin dryer 10 shown here, the opening 15 in the drum housing 14 can be closed by a pivotable door 16.

The drum housing 14 comprising the drum 12, which is rotatably mounted therein, can be pivoted about a pivot axis 17 which runs transverse to the axis of rotation 11 of the drum 12. The pivot axis 17 runs horizontally, so that, for loading and unloading purposes, the drum 12 together with the drum housing 14 can be pivoted such that the openings 13 and 15 point upward in an at least slightly inclined manner (loading position) or are directed obliquely downward (unloading position) In order to operate the spin dryer 10, the drum 12 together with the drum housing 14 can be pivoted into a washing position in which the axis of rotation 11 of the drum 12 runs horizontally, inclined or else perpendicular.

The drum housing 14 is mounted on a basic frame 18 of the spin dryer 10 by the pivot axis 17. In the spin dryer 10 shown, four preferably identical feet 19 are arranged on the lower face 21 of the basic frame 18. The spin dryer 10 stands on the floor of a laundry by means of the feet 19.

Details regarding mounting of the drum housing 14 on the basic frame 18 and the drives for pivoting the drum housing 14 with respect to the basic frame 18 and for driving the drum 12 in rotation are known per se, for example from German Patent Application No. DE 103 43 306 AI in connection with a laundry centrifuge, and from German Patent Application No. DE 10 2004 002 585 A1 in connection with a spin dryer. In this respect, reference is made to these documents.

The spin dryer 10 shown here is provided with at least one weight sensor 20. As a result, the spin dryer 10 is weighed. The weight of the contents of the drum 12 can be determined on account of this weighing operation. Changes in the weight of the dry or still wet laundry in the drum 12 over time, as occur during unloading for example, can be established by means of a plurality of weight measurements which follow one another at regular time intervals or by means of continuous uninterrupted weight measurements. However, dynamic forces which occur when the drum 12, in particular the loaded drum 12, is driven in rotation can also be determined in this manner. The at least one weight sensor 20 is preferably associated with the basic frame 18. The weight sensor 20 is preferably arranged in the region of the lower face 21 of the basic frame 18, to be precise between the basic frame 18 and the respective foot 19 in this case.

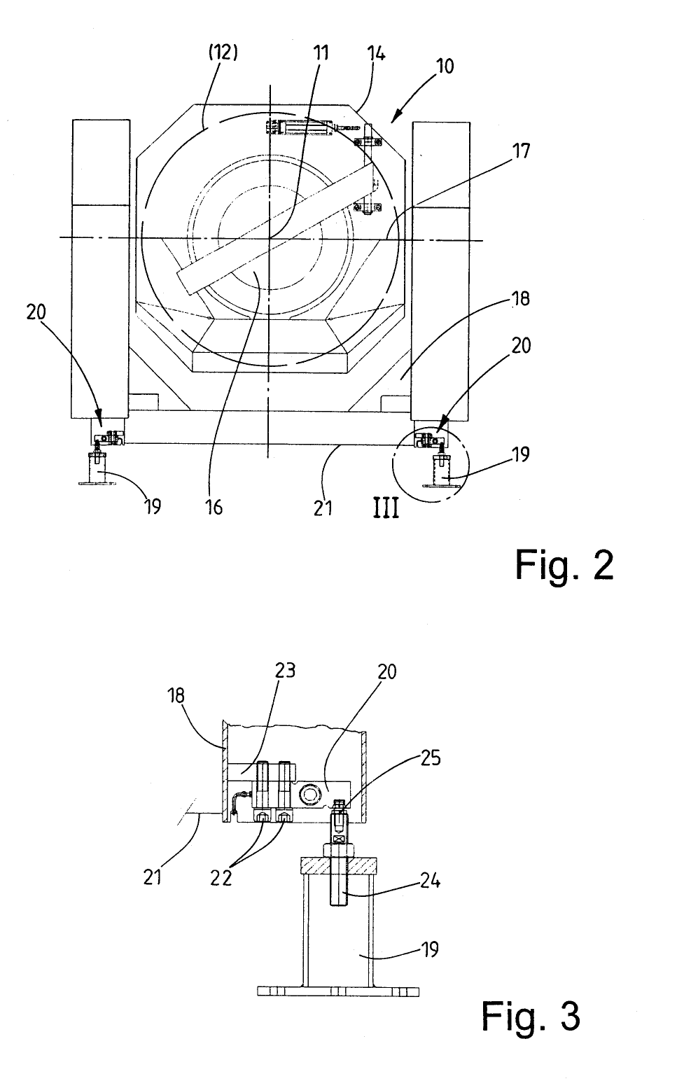

Four weight sensors 20 are provided in the exemplary embodiment shown. These sensors are identical weight sensors 20. The weight sensors 20 are installed in a lower region of the basic frame 18, to be precise such that one weight sensor 20 is supported on each of the four feet 10 (FIGS. 2 and 3). The figures show that the weight sensors 20 are arranged within the outline of the basic frame 18, to be precise in the vicinity of the lower face 21 of the basic frame 18. As a result, the weight sensors 20 are positioned such that they are protected in the interior of the basic frame 18 which is hollow in the region of the weight sensors 20, particularly when the spin dryer 10 is transported. It is therefore also possible for the weight sensors 20 to be associated with the feet 19 by each of the four weight sensors 20 being supported on one of the likewise four feet 19 (FIG. 3). The weight sensors 20 which are firmly connected to the basic frame 18 in the lower region are therefore subjected to almost the entire weight of the spin dryer 10, specifically of the basic frame 18, the drum housing 14 and the drum 12 together with its contents.

Provision is preferably made for the casing and the at least one switchgear cabinet to be separate from the basic frame 18. As a result, interfering influences which could affect the result of the measurement of the weight sensors 20 are avoided, to be precise just like flexible media supply lines.

In the spin dryer 10 shown here, each weight sensor 20 is in the form of a shear beam load cell. The shear beam load cell has a corresponding measuring range depending on the size of the spin dryer 10. A shear beam load cell which can determine weights of up to 5 t is generally sufficient. Each of the shear beam load cells is preferably formed in accordance with the 6-wire technique and provided with a measurement amplifier. However, it is also feasible to provide one measurement amplifier for all four weight sensors 20, specifically shear beam load cells. Customary measurement, evaluation and display electronics are provided downstream of the measurement amplifier or amplifiers. Provision is expediently also made for a computer which processes, calculates and possibly also stores the measurement signals from the weight sensors 20. The latter is particularly expedient when, according to one preferred exemplary embodiment of the invention, the weight sensors 20 supply successive measurement signals, to be precise at uninterrupted intervals or with a time interval, with the breaks between the successive measurements expediently being of equal length in the last-mentioned case.

The shear beam load cells are firmly connected to the basic frame 18 at one end. In the exemplary embodiment shown, approximately half of each shear beam load cell is screwed by a plurality of screws 22 to a crossbeam 23 which is firmly connected to the basic frame 18. The resulting releasable connection between the shear beam load cell and the basic frame 18 is made such that the elongate shear beam is located in the basic frame 18 in a horizontally directed manner, with a second half of the elongate shear beam load cell protruding in a freely projecting manner with respect to the horizontally crossbeam 23 of the basic frame 18 (FIG. 3). An outer end region of the lower face of that part of the shear beam load cell which protrudes freely with respect to the crossbeam 23 of the basic frame 18 rests on the respective foot 19. To this end, each foot 19 has a threaded rod 24 or else a screw. The threaded rod 24 is screwed into the foot 19 and is brought into contact with the free projecting end of the shear beam load cell (weight sensor 20) by an upper free end 25. The end 25 of the threaded rod 24 may possibly be secured in a corresponding recess in the shear beam load cell, for example by being tightly screwed. In order to horizontally orient the spin dryer 10, the threaded rod 24 can be screwed into the foot 19 to a greater or lesser extent, so that the free end 25 of the threaded rod 24 is at a corresponding distance from the upper face of the foot 19.

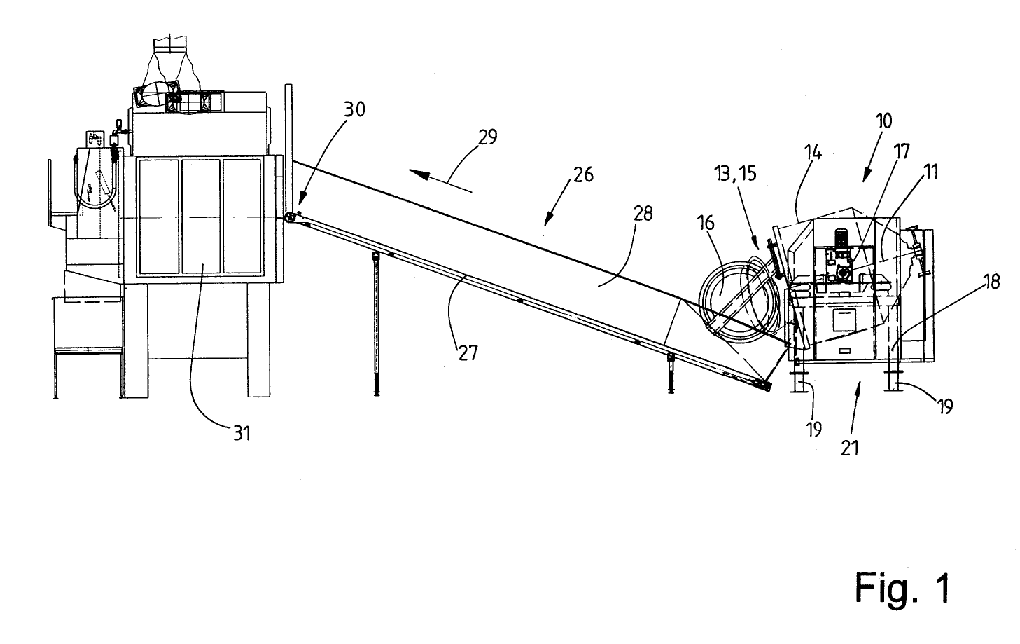

FIG. 1 shows that the spin dryer 10 has an associated unloading belt 26 on the unloading side. In the simplest case, said unloading belt is a conveyor belt. Opposite sides of the upper strand 27 of the unloading belt 26 preferably have associated stationary guide walls 28, as a result of which the unloading belt 26 is in the form of a channel for laterally guiding the laundry which is transported further on the unloading belt 26. The unloading belt 26 shown here rises slightly in the conveying direction 29. However, the unloading belt 26 may also run horizontally or in a slightly inclined manner. The end 30 of the unloading belt 26 is associated with a dryer 31. In this way, the laundry can be transported from the spin, dryer 10 to the dryer 31 by means of the unloading belt 26 in order to load the dryer 31 with the laundry arriving from the spin dryer 10.

The inventive method will be explained in greater detail below with reference to the spin dryer 10 described above:

The weight sensors 20 continuously, to be precise either in an uninterrupted sequence or at regular time intervals which follow one another with specific, preferably equal, breaks, determine the weight of that part of the spin dryer 10 which rests on the feet 19 and therefore on the weight sensors 20 which are arranged between the spin dryer 10 and the feet 19. In the process, the drum 12 together with its contents, the drum housing 14, the basic frame 18 and the parts which are associated with said components of the spin dryer 10, in particular drives, are weighed continuously or from time to time. Since this weight, apart from dynamic forces, is always constant, the weight of the contents of the drum 12 can be determined by subtracting the empty weight of the components of the spin dryer 10 which rest on the weight sensor 20.

The weight of the contents of the drum 12 can be determined by the weight sensors 20 even when the drum 12 is driven in rotation if dynamic forces which are possibly produced by the loaded drum 12 being driven are added. Since the dynamic forces are of a periodic nature and weight is measured continuously over time, the dynamic forces lead alternately to an increase and a reduction in the weight of the spin dryer 10, including the contents of the drum 12, determined by the weight sensors 20. An average value of the periodically fluctuating weight measurement values leads to the weight of the contents of the drum 12 being determined without taking dynamic force components into account. The inventive method therefore allows the weight or the weight force of the contents of the drum 12 to be determined both when the drum 12 is stationary and when it is driven in rotation.

In many cases, the dryer 31 which is downstream of the sin dryer 10 receives only part of the batch of laundry from the spin dryer 10. In the text which follows, it is assumed that the dryer 31 receives only half of the batch of laundry from the spin dryer 10. However, the time required by the dryer 31 to dry the laundry, specifically to remove at least the majority of the residual moisture from the laundry, is less than the cycle time of the spin dryer 10, that is to say the time which said spin dryer requires to wash and spin-dry the laundry. In the text which follows, it is assumed that the cycle time of the dryer 31 corresponds only to half the cycle time of the spin dryer 10.

So-called batch division is customarily carried out on account of the different capacities and cycle durations of the spin dryer 10 and the dryer 31. To this end, the batch of laundry in the spin dryer 10 is divided when it is unloaded. In the case adopted here, where the capacity of the dryer 31 is half that of the spin dryer 10, the batch of laundry in the spin dryer 10 is divided into two partial batches of identical size, specifically into batch halves in the example adopted here. Batch division is therefore uniform in this case. This batch division is supported by the weight of the essential parts of the spin dryer 10, including the laundry in the drum 12 which has a specific residual moisture, which rest on the weight sensors 20 being established continuously. The weight of the entire batch of laundry, which still contains residual moisture and is located in the drum 12, at and before the beginning of unloading is known on account of the known weight of the components of the spin dryer 10 which rest on the weight sensors 20.

When the batch is divided into two partial batches of approximately equal size and/or equal weight, the spin dryer 10 is gradually unloaded, with the laundry which is being unloaded and still contains residual moisture being passed onto the unloading belt 26. It is possible to determine when half the amount of the laundry which still contains residual moisture has left the drum 12 of the spin dryer 10 on account of the periodic or continuous weight measurement over a certain period of time. A partial batch which corresponds approximately to half the weight of the batch of laundry in the spin dryer 10 is then located on the unloading belt 26. The unloading process of the spin dryer 10 is then briefly interrupted. When the first partial batch is unloaded, it is transported to the dryer 31 by the unloading belt 26 in a continuous or else cyclical manner and said dryer is thus loaded, if it is free at this time. The drying process of the first partial batch can now begin in the dryer 31. The rest of the laundry which still contains residual moisture is then unloaded from the drum 12 of the spin dryer 10. This remaining laundry corresponds to the second partial batch of approximately the same weight as the first partial batch. This partial batch remains on the unloading belt 26 until the first partial batch is dry. The second partial batch is then transported to the dryer 31 by the unloading belt 26, and the dryer 31 is therefore loaded with the second partial batch.

If the dryer 31 is still operating while the first partial batch is being unloaded, that is to say is not ready to receive the partial batch, the first partial batch from the spin dryer 10 is unloaded onto the stationary unloading belt 26. The first partial batch is then stored on the unloading belt 26 in a pile. As soon as the first partial batch is formed, unloading of the spin dryer 10 is briefly interrupted and the drive of the unloading belt 26 is briefly started. As a result, the first partial batch is conveyed toward the dryer 31 by the unloading belt 26. The second partial batch can then be formed by completely unloading the spin dryer 10, with the partial batches being located on the unloading belt 26 separately from one another. As soon as the dryer 31 is ready to receive again, the first partial batch is loaded into the dryer 31 by the unloading belt 26. The subsequent, second partial batch remains on the unloading belt 26 until the first partial batch is dry and the dryer 31 is ready to receive the second partial batch.

If more than two partial batches of the laundry which is contained in the spin dryer 10 need to be formed because the dryer can only accommodate less than half the batch of laundry in the spin dryer 10, a corresponding number of partial batches of equal size are formed. If, by way of example, three partial batches of identical size are formed, the process is again based on the total weight of the batch of laundry, which still contains residual moisture, in the drum 12, which total weight is established before or at the beginning of unloading of the spin dryer 10. The first partial batch is now formed by subtracting the weight of the partial batch, in the present example ⅓ of the total weight of the batch, from the total weight of the batch of laundry. The laundry which still contains residual moisture is then unloaded from the spin dryer 10 until the continuous weight measurement establishes that only ⅔ of the total weight of the batch of laundry, which still contains residual moisture, is present in the drum 12. The formation of the first partial batch is now concluded. The second partial batch is formed in an analogous manner by the drum 12 being unloaded until only ⅓ of the total weight of the entire batch of still wet laundry is present in the drum. The third partial batch is formed by all of the remaining laundry being unloaded from the drum 12. The partial batches are stored at a distance from one another on the unloading belt 26. To this end, the unloading belt 26 is not driven while the drum 12 of the spin dryer 10 is being unloaded, that is to say while the respective partial batch is being formed. After the respective partial batch is formed and the unloading process of the spin dryer 10 is briefly interrupted, the unloading belt 26 is driven for an instant. In this way, the individual partial batches on the unloading belt 26 are separated and preferably somewhat spaced apart from one another. Whenever the dryer 31 is ready to receive a new partial batch, a partial batch is respectively transported to the dryer 31 by the unloading belt 26 and the dryer 31 is loaded in the process.

The invention is also suited to use in connection with loading and unloading other laundry machines, for example laundry centrifuges. Batches are formed in this case too, that is to say a (large) batch is deliberately divided in terms of weight into two or more than two partial batches by continuously or periodically weighing at least a part of the laundry machine which contains the respective batch or a remainder of the latter.

If the laundry is not washed and spun-dry in a spin dryer 10 but in separate laundry machines, specifically a washing machine and a downstream laundry centrifuge, the above-described batch formation takes place when the laundry centrifuge is unloaded. The weight of the spun laundry, which contains a certain residual moisture and is located in the drum of the laundry centrifuge, is determined at the beginning of or before unloading in this case too, as a result of which the total weight of the batch of laundry in the drum of the laundry centrifuge is known. Two or more partial batches from the complete batch of laundry in the drum of the laundry centrifuge are then deliberately formed by continuous, uninterrupted weight measurement or by weight measurement interrupted by regular breaks at least of the laundry, which still contains residual moisture, in the drum. The partial batches are transported away by the unloading belt 26 in the same way as described above in connection with the spin dryer 10.

If the laundry centrifuge which is downstream of the washing machine has a lower capacity than the washing machine and possibly also different cycle times, the inventive batch division can also be performed between the washing machine and the laundry centrifuge, that is to say when the washing machine is unloaded. In this case, the process is carried out in exactly the same way and the unloading belt is driven in exactly the same way as described above in connection with the spin dryer 10.

Finally, batch division can also be performed when the dryer 31 is unloaded. In this case, no unloading belt 26 needs to be arranged downstream of the dryer 31.

It is also feasible to provide, in place of the unloading belt 26, another conveying means, for example a laundry carriage, pneumatic conveyor or the like, in order to unload the spin dryer 10, the laundry centrifuge, the washing machine and/or the dryer 31.

### LIST OF REFERENCE SYMBOLS

10 Spin dryer
11 Axis of rotation
12 Drum
13 Opening
14 Drum housing
15 Opening
16 Door
17 Pivot axis
18 Basic frame
19 Foot
20 Weight sensor
21 Lower face
22 Screw
23 Crossbeam
24 Threaded rod
25 End
26 Unloading belt
27 Upper strand
28 Guide wall
29 Conveying direction
30 End
31 Dryer

What is claimed is:

1. A method for dividing a batch of laundry which is treated in a laundry machine into a plurality of partial batches, wherein the weight of the laundry in the laundry machine is determined.

2. The method as claimed in claim 1, wherein the weight of the laundry in the laundry machine is determined before or at the beginning of and during unloading of the laundry from the laundry machine.

3. The method as claimed in claim 1, wherein the weight of the partial batch of laundry which is still present in the laundry machine is determined during the unloading process.

4. The method as claimed in claim 1, wherein, in order to form an unloaded partial batch of laundry with a specific weight, such an amount of laundry is unloaded until determination of the weight of the laundry remaining in the laundry machine shows that this weight of the laundry corresponds to the previously determined weight of the entire batch of the laundry in the laundry machine minus the weight of the partial batch to be formed.

5. The method as claimed in claim 1, wherein, in order to form two partial batches of approximately the same weight, such an amount of laundry is unloaded until the weight of the laundry remaining in the laundry machine, which weight is determined over time, corresponds to half the weight of the batch.

6. The method as claimed in claim 1, wherein the laundry from the laundry machine is loaded onto a conveyor.

7. The method as claimed in claim 6, wherein the partial batches are successively transported from the conveyor to a downstream laundry machine.

8. The method as claimed in claim 7, wherein the partial batches are intermediately stored on the conveyor.

9. An apparatus for treating laundry, comprising a drum (12), which can preferably be driven in rotation, for accommodating a batch of the laundry to be treated, distinguished by at least one weight sensor (20) for determining at least the weight of the drum (12) together with the laundry which is located therein at the time at which the weight is determined.

10. The apparatus as claimed in claim 9, wherein the at least one weight sensor (20) is associated with a basic frame (18) for mounting the drum (12).

11. The apparatus as claimed in claim 10, wherein the at least one weight sensor (20) is arranged in the vicinity of a foot (19) which is used to support the basic frame (18) on the floor.

12. The apparatus as claimed in claim 10, wherein the basic frame (18) comprising the drum (12) is supported on the at least one weight sensor (20).

13. The apparatus as claimed in claim 9, wherein the at least one weight sensor (20) is arranged in the basic frame (18) in such a way that the weight sensor (20) which bears the basic frame (18) comprising the drum (12) is supported on the respective foot (19).

14. The apparatus as claimed in claim 11, wherein each foot (19) of the basic frame (18) has an associated weight sensor (20).

15. The apparatus as claimed in claim 9, wherein the at least one weight sensor (20) operates in a capacitive, inductive or piezoelectric manner, or in accordance with the strain gauge principle.

16. The apparatus as claimed in claim 9, wherein the at least one weight sensor (20) is in the form of a load cell or a force pickup cell.

17. The method as claimed in claim 2, wherein the weight of the partial batch of laundry which is still present in the laundry machine is determined during the unloading process.
